(19) United States
(12) Patent Application Publication
(10) Pub. No.: US 2026/0166646 A1
(43) Pub. Date: Jun. 18, 2026

(54) LASER IRRADIATION POSITION MEASUREMENT METHOD AND LASER WELDING INSPECTION METHOD

(71) Applicant: HONDA MOTOR CO., LTD., Tokyo (JP)

(72) Inventors: Shunta AKIYA, Saitama (JP); Yasuhiro KAWAI, Saitama (JP); Toru EGUCHI, Saitama (JP)

(21) Appl. No.: 19/422,449

(22) Filed: Dec. 17, 2025

(30) Foreign Application Priority Data
Dec. 18, 2024 (JP) 2024-221827

(51) Int. Cl. B23K 26/03; B23K 31/12

(52) U.S. Cl. CPC B23K 26/032; B23K 31/125

(57) ABSTRACT

A laser irradiation position measurement method is a method of measuring an irradiation position of laser welding light with respect to a welding target member including a first member and a second member extending in a direction intersecting the first member, and includes: step ST1 of projecting the laser welding light while wobbling the laser welding light on a target surface of the welding target member, and acquiring time-series data of a melting depth at an irradiation point of the laser welding light; step ST2 of performing frequency analysis on the time-series data acquired at step ST1 and acquiring spectral data; step ST3 of acquiring, from the spectral data acquired at step ST2, an intensity value at at least one peak as an input value; and step ST4 of calculating a central irradiation position of the laser welding light based on the input value acquired at step ST3.

This application is based on and claims the benefit of priority from Japanese Patent Application No. 2024-221827, filed on 18 Dec. 2024, the content of which is incorporated herein by reference.

### BACKGROUND OF THE INVENTION

### Field of the Invention

The present invention relates to a laser irradiation position measurement method and a laser welding inspection method. More specifically, the present invention relates to a laser irradiation position measurement method of measuring the irradiation position of laser welding light with respect to a target member while wobbling the laser welding light on a target surface of the target member, and a laser welding inspection method of inspecting the quality of a weld formed in the target member by wobbling-welding.

### Related Art

Recently, research and development related to secondary batteries that contribute to energy efficiency has been carried out so that more people can secure access to affordable, reliable, sustainable, and advanced energy.

For example, Japanese Unexamined Patent Application, Publication No. 2011-249243 discloses a so-called laminate-cell-type secondary battery in which a plurality of plate-shaped batteries called laminate cells are disposed in a stacked manner. In such a laminate-cell-type secondary battery, tab leads of cell electrodes of the respective laminate cells and a busbar are welded to electrically connect the cell electrodes in series and/or in parallel.

Patent Document 1: Japanese Unexamined Patent Application, Publication No. 2011-249243

### SUMMARY OF THE INVENTION

The shape of a welded joint between a tab lead and a busbar is typically a lap joint as described in, for example, Japanese Unexamined Patent Application, Publication No. 2011-249243. However, recently, it may be difficult to form a lap joint by bending as disclosed in Japanese Unexamined Patent Application, Publication No. 2011-249243 due to a tendency for the plate thickness of an electrode to increase along with rapid charging. In such a case, by employing a T-butt shape in which a welded joint has a T shape in a sectional view, the tab lead can be welded to the busbar without bending.

In a case where a T-butt shape is employed as the shape of a welded joint, it is needed to project laser welding light in a tilted manner, but in this case, the quality of a joint largely varies depending on the irradiation position of the laser welding light with respect to a welding target member. Specifically, melting amounts of the metal tab lead and the busbar vary depending on the irradiation position of the laser welding light, and internal defects may occur or joint strength may be insufficient. Thus, in order to guarantee the quality of a product, the irradiation position of the laser welding light needs to be measured.

The present invention is intended to provide a laser irradiation position measurement method of measuring the irradiation position of laser welding light with respect to a target member and a laser welding inspection method of inspecting the quality of a joint formed in a target member by projecting laser welding light, and accordingly, contributes to improvement in energy efficiency.
(1) A laser irradiation position measurement method according to the present invention is a method of measuring an irradiation position of laser welding light with respect to a target member including a first member and a second member extending in a direction intersecting the first member, the laser irradiation position measurement method including: (A) projecting the laser welding light while wobbling the laser welding light on a target surface of the target member, and acquiring time-series data of a depth at an irradiation point of the laser welding light; (B) performing frequency analysis on the time-series data and acquiring spectral data; (C) acquiring, from the spectral data, an intensity value at at least one peak or an integral value of the intensity value as an input value; and (D) calculating the irradiation position of the laser welding light based on the input value.
(2) In this case, it is preferable that in (D), the irradiation position be calculated by comparing a curve defining a correlation between the intensity value or the integral value and the irradiation position with the input value.
(3) In this case, it is preferable that in (C), two or more peaks be selected from among a plurality of peaks, and the intensity value or the integral value at each of the selected peaks be acquired as the input value, and in (D), the irradiation position be calculated by comparing two or more of the input values acquired in (C) with two or more of the curves determined for the respective selected peaks in (C).
(4) In this case, it is preferable that in (C), the intensity value or the integral value at a peak at a frequency corresponding to a wobbling frequency among a plurality of peaks be acquired as the input value.
(5) In this case, it is preferable that in (C), the intensity value or the integral value at a peak appearing at a lowest frequency among a plurality of peaks be acquired as the input value.
(6) In this case, it is preferable that in (A), the laser welding light be tilted so as to intersect both the first member and the second member at an angle greater than 0° and less than 90° on the target surface.
(7) In this case, it is preferable that in (A), the laser welding light and measurement light be wobbled on the target surface while being coaxially projected, and the time-series data be acquired by detecting the measurement light reflected from the irradiation point.
(8) A laser welding inspection method according to the present invention is a method of inspecting quality of a joint formed by projecting laser welding light onto a target member including a first member and a second member extending in a direction intersecting the first member, the laser welding inspection method including: (A) projecting the laser welding light while wobbling the laser welding light on a target surface of the target member, and acquiring time-series data of a depth at an irradiation point of the laser welding light; (B) performing frequency analysis on the time-series data and acquiring spectral data; (C) acquiring, from the spectral data, an intensity value at at least one peak or an integral value of the intensity value as an input value; and (D) inspecting the quality of the joint based on the input value.
(1) In the present invention, (A) laser welding light is projected while the laser welding light is wobbled on a target surface of a target member including a first member and a second member extending in a direction intersecting the first member, and time-series data of a depth at the irradiation point of the laser welding light is acquired; (B) spectral data is acquired by performing frequency analysis on the time-series data; and (C) an intensity value representing the magnitude of at least one peak or an integral value of the intensity value is acquired as an input value from among a plurality of peaks appearing in the spectral data. When the laser welding light is projected while being wobbled with respect to the target member formed by combining the first and second members as described above, the waveform of a depth at the irradiation point, periodically changes. In particular, as described below with reference to FIGS. 7 and 9, the magnitude of a peak appearing at a particular frequency in spectral data of the waveform of the depth has correlation with the irradiation position of the laser welding light with respect to the target member. In the present invention, the relation between the magnitude of a peak appearing in such spectral data and the irradiation position is utilized to (D) calculate the irradiation position of the laser welding light based on the input value acquired in (C). Thus, according to the present invention, the irradiation position of the laser welding light can be measured while the first member and the second member are welded by so-called wobbling-welding. In a case where the target member is a tab lead and a busbar of a secondary battery as described above, the irradiation position of the laser welding light has correlation with the quality of a product, and since the irradiation position of the laser welding light can be measured by utilizing the present invention, high-quality secondary batteries can be manufactured, which can contribute to improvement in energy efficiency.
(2) In the present invention, in (D), the irradiation position is calculated by comparing a curve defining the correlation between the intensity value or the integral value and the irradiation position with the input value acquired in (C). Thus, according to the present invention, the irradiation position can be calculated by simple calculation.
(3) As described below with reference to FIG. 9, the curve defining the correlation between the intensity value or the integral value and the irradiation position may be a multivalued function with respect to the intensity value or the integral value, and in this case, the irradiation position cannot be uniquely determined from the intensity value or the integral value. Thus, in (C), two or more peaks are selected from among a plurality of peaks appearing in the spectral data and the intensity value or the integral value at each of the selected peaks is acquired as the input value, and in (D), the irradiation position is calculated by comparing the two or more input values acquired in (C) with the two or more curves determined for the respective selected peaks in (C). In this manner, in the present invention, by utilizing the two or more input values, the irradiation position can be uniquely calculated even when the curves are multivalued functions as described above.
(4) As described below with reference to FIG. 7, in spectral data of the waveform of the depth, peaks appear at one or more particular frequencies determined in accordance with a wobbling frequency. Thus, in (C), the intensity value or the integral value at a peak at a frequency corresponding to the wobbling frequency among a plurality of peaks is acquired as the input value. Thus, according to the present invention, the irradiation position can be calculated by simple calculation.
(5) As described below with reference to FIG. 7, a peak appearing at the lowest frequency tends to have the largest magnitude among a plurality of peaks appearing in spectral data of the waveform of the depth. Thus, in (C), the intensity value or the integral value at a peak appearing at the lowest frequency among a plurality of peaks appearing in the spectral data is acquired as the input value, and accordingly, the irradiation position can be accurately calculated.
(6) In the present invention, in (A), the laser welding light is tilted so as to intersect both the first member and the second member at an angle greater than 0° and less than 90° on the target surface of the target member, and accordingly, the irradiation position of the laser welding light can be measured while the first member and the second member are appropriately joined by welding.
(7) In the present invention, in (A), the laser welding light and measurement light are wobbled on the target surface while being coaxially projected, and the time-series data of the depth is acquired by detecting the measurement light reflected from the irradiation point. Accordingly, time-series data of a melting depth at an irradiation point that moves by wobbling laser welding light L can be easily acquired.
(8) In the present invention, the input value is acquired through (A), (B), and (C). The magnitude of a peak appearing at a particular frequency in the spectral data acquired in (B) as described above has correlation with the irradiation position of the laser welding light with respect to the target member, and the irradiation position of the laser welding light with respect to the target member has correlation with the quality of a joint. In other words, the magnitude of a peak in the spectral data has correlation with the quality of a joint. In the present invention, such a relation between the magnitude of a peak appearing in the spectral data and the quality of a joint is utilized to (D) inspect the quality of the joint based on the input value acquired in (C). Thus, according to the present invention, the quality of a joint formed by projecting the laser welding light can be inspected while the first member and the second member are welded by so-called wobbling-welding. Thus, by utilizing the present invention, high-quality secondary batteries can be manufactured, which can contribute to improvement in energy efficiency.

### BRIEF DESCRIPTION OF THE DRAWINGS

FIG. 1 is a diagram schematically illustrating the configuration of a laser welding system according to an embodiment of the present invention;

FIG. 2 is a diagram schematically illustrating the configuration of a welding target member;

FIG. 3 is a flowchart illustrating specific procedures of a laser irradiation position measurement method and a laser welding inspection method;

FIG. 4 is a diagram illustrating an example of a wobbling pattern of laser welding light;

FIG. 5 is a diagram for description of the definition of an irradiation position of laser welding light when the laser welding light is projected while being wobbling;

FIG. 6A is a diagram illustrating an example of time-series data of a melting depth (central irradiation position=0.05 [mm]);

FIG. 6B is a diagram illustrating an example of time-series data of the melting depth (central irradiation position=0.16 [mm]);

FIG. 6C is a diagram illustrating an example of time-series data of the melting depth (central irradiation position=0.24 [mm]);

FIG. 6D is a diagram illustrating an example of time-series data of the melting depth (central irradiation position=0.39 [mm]);

FIG. 7 is a diagram illustrating an example of spectral data of time-series data of the melting depth;

FIG. 8 is a diagram for description of a procedure of acquiring an input value from a peak appearing at a predetermined frequency in spectral data;

FIG. 9 is a diagram illustrating the correlation between the magnitude of a peak appearing at a specific frequency in spectral data and the central irradiation position;

FIG. 10 is a diagram schematically illustrating the correlation between the shape of a peak appearing at a predetermined frequency in spectral data and the central irradiation position; and

FIG. 11 is a flowchart illustrating a specific procedure of the laser welding inspection method according to a modification.

### DETAILED DESCRIPTION OF THE INVENTION

The configuration of a laser welding system according to an embodiment of the present invention and the procedures of a laser irradiation position measurement method and a laser welding inspection method using the laser welding system will be described below with reference to the accompanying drawings.

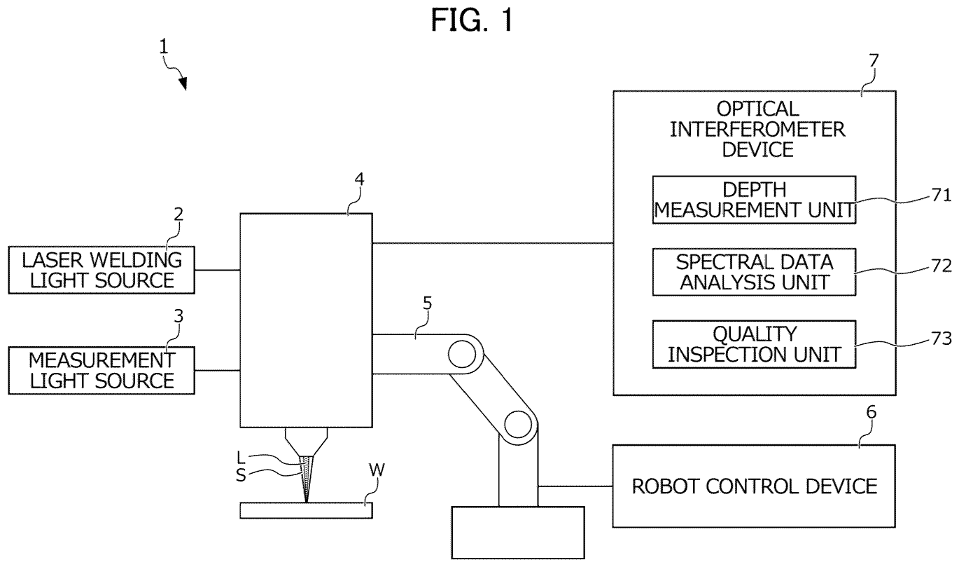

FIG. 1 is a diagram schematically illustrating the configuration of a laser welding system 1 according to the present embodiment.

The laser welding system 1 includes a laser welding light source 2 configured to generate laser welding light, a measurement light source 3 configured to generate measurement light, a laser head 4 configured to project the laser welding light and the measurement light onto a target surface of a welding target member W constituted by a plurality of members, a robot 5 configured to support the laser head 4, a robot control device 6 that is a computer configured to control the robot 5, and an optical interferometer device 7 that is a computer configured to measure a melting depth at the irradiation point of the laser welding light and the irradiation position of the laser welding light. The laser welding system 1 welds the welding target member W while measuring the melting depth and the irradiation position by using the laser welding light source 2, the measurement light source 3, the laser head 4, the robot 5, the robot control device 6, and the optical interferometer device 7 in combination.

Laser welding light L generated by the laser welding light source 2 enters the laser head 4 through a transmission fiber and is projected onto a target surface of the welding target member W through an optical system inside the laser head 4.

The measurement light source 3 generates measurement light (for example, near-infrared light) having a wavelength different from that of the laser welding light L. The measurement light occurred by the measurement light source 3 is divided into first measurement light S and second measurement light (not illustrated) by a non-illustrated semi-reflective mirror. Through the optical system inside the laser head 4, the first measurement light S is coaxially superposed with the laser welding light L and projected onto the irradiation position of the laser welding light L on the target surface of the welding target member W. Part of the first measurement light S projected from the laser head 4 is reflected by the welding target member W and enters the optical interferometer device 7 through the optical system provided inside the laser head 4. On the other hand, the second measurement light is reflected by a non-illustrated reference mirror and enters the optical interferometer device 7.

The laser head 4 projects coaxially the laser welding light L and the first measurement light S onto the target surface of the welding target member W. The laser head 4 includes a laser scanning device (not illustrated) configured to two-dimensionally scan the laser welding light L and the first measurement light S by swinging a Galvano mirror.

The robot 5 includes an articulated arm supporting the laser head 4 at a tip portion of the robot 5. The robot control device 6 controls the position and posture of the laser head 4 with respect to the welding target member W by driving the articulated arm of the robot 5. The robot control device 6 also has a function to control a laser scanning device provided at the laser head 4. Thus, by controlling the laser scanning device while controlling the position and posture of the laser head 4, the robot control device 6 can wobble the laser welding light L and the first measurement light S on the target surface in a wobbling pattern having an optional shape and an optional period, while coaxially projecting the laser welding light L and the first measurement light S onto the target surface of the welding target member W.

The optical interferometer device 7 includes a depth measurement unit 71 configured to measure the melting depth of the welding target member W at the irradiation point of the laser welding light L by detecting the first measurement light S and the second measurement light, a spectral data analysis unit 72 configured to measure the irradiation position of the laser welding light L with respect to the welding target member W based on a result of the melting depth measurement by the depth measurement unit 71, and a quality inspection unit 73 configured to inspect the quality of a weld of the welding target member W based on an analysis result by the spectral data analysis unit 72.

The depth measurement unit 71 measures the melting depth at the irradiation point of the laser welding light L based on optical coherence tomography (OCT). More specifically, the depth measurement unit 71 measures time-series data of the melting depth at the irradiation position of the laser welding light L, which moves by wobbling as described above, by performing interference measurement, based on a known algorithm, between the first measurement light S reflected from the welding target member W and the second measurement light reflected from the reference mirror.

The spectral data analysis unit 72 measures the irradiation position of the laser welding light L with respect to the welding target member W based on the time-series data of the melting depth measured by the depth measurement unit 71. As described below in detail, the spectral data analysis unit 72 first acquires spectral data by performing frequency analysis on the time-series data of the melting depth. Subsequently, the spectral data analysis unit 72 acquires, from the acquired spectral data, the intensity value at at least one peak or an integral value of the intensity value as an input value. Subsequently, the spectral data analysis unit 72 calculates the irradiation position of the laser welding light L based on the acquired input value.

The quality inspection unit 73 inspects the quality of a weld formed in the welding target member W by projecting the laser welding light L based on a spectral data analysis result by the spectral data analysis unit 72 (more specifically, the input value obtained from the spectral data, or the irradiation position of the laser welding light L obtained from the input value).

The following describes specific procedures of a laser irradiation position measurement method of measuring the irradiation position of the laser welding light L with respect to the welding target member W while welding the welding target member W by the laser welding system 1 as described above, and a laser welding inspection method of inspecting the quality of a weld while welding the welding target member W.

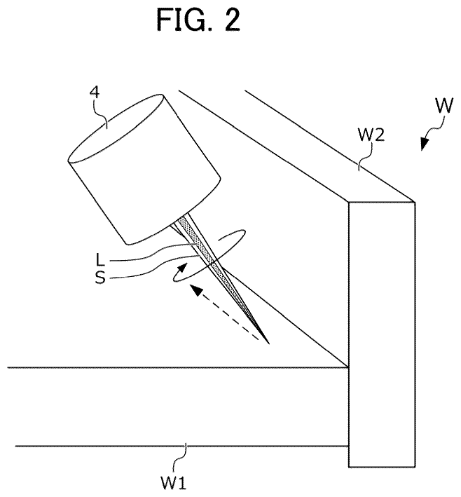

FIG. 2 is a diagram schematically illustrating the configuration of the welding target member W. In the following, a case where the welding target member W is a combination of two members W1 and W2 as illustrated in FIG. 2 will be described as a preferable application example of the laser irradiation position measurement method according to the present invention. As illustrated in FIG. 2, the welding target member W is constituted by the first member W1 having a plate shape at least at a joint, and the second member W2 having a plate shape at least at the joint and extending in a direction intersecting (for example, orthogonal to) the first member W1. In the following, a case where the shape of a welded joint between the first member W1 and the second member W2 is a T-butt shape having a T shape in a sectional view will be described, but the present invention is not limited thereto. Moreover, in the following, a case where the welding target member W is a component of a laminate-cell-type secondary battery, more specifically, when the first member W1 is a busbar of the secondary battery and the second member W2 is a tab lead of the secondary battery will be described, but the present invention is not limited thereto.

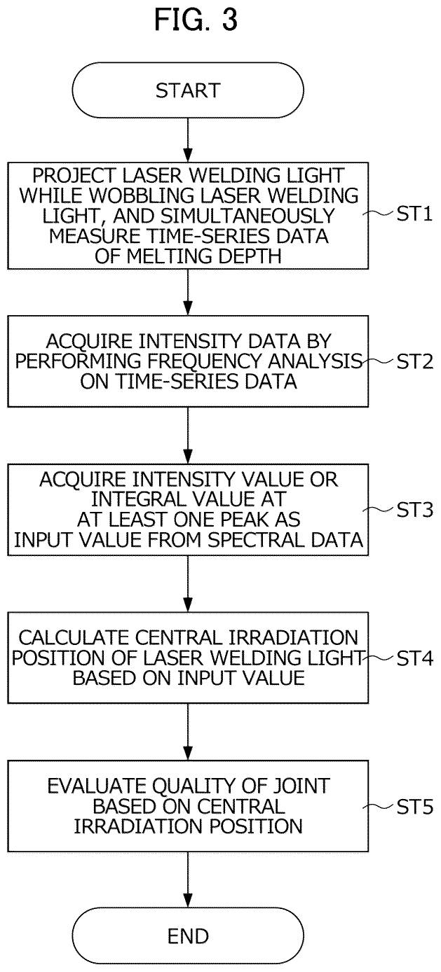

FIG. 3 is a flowchart illustrating specific procedures of the laser irradiation position measurement method and the laser welding inspection method using the laser welding system 1.

First at step ST1, the laser welding light L is projected while being wobbled on the target surface of the welding target member W, and time-series data of the melting depth at the irradiation point of laser welding light L1 is measured. More specifically, the robot control device 6 projects the laser welding light L and the first measurement light S while wobbling the laser welding light L and the first measurement light S on the target surface under a predetermined wobbling period, and simultaneously, the depth measurement unit 71 acquires time-series data of the melting depth at the irradiation point of the laser welding light L, which moves by the wobbling.

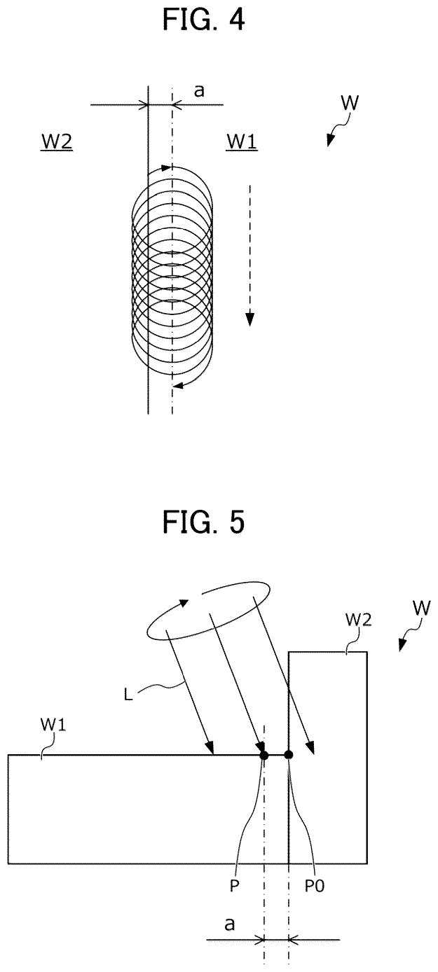

FIG. 4 is a diagram illustrating an example of a wobbling pattern of the laser welding light L. More specifically, FIG. 4 is a view taken in the axial direction of the laser welding light L, illustrating an example of a wobbling pattern drawn on a target surface of the first member W1 and the second member W2. In the following, a case where the shape of the wobbling pattern is a circular shape in a plan view as illustrated in FIG. 4 will be described, but the present invention is not limited thereto. The shape of the wobbling pattern of the laser welding light L is not limited to a circular shape, but may be any periodic shape such a triangular shape, a linear shape, or an 8-figure shape.

At step ST1, the robot control device 6 scans the laser welding light L on the target surface of the first member W1 and the second member W2 under a predetermined wobbling period in accordance with a predetermined wobbling pattern by controlling the laser scanning device, and simultaneously moves the laser head 4 in a seam direction (refer to dashed arrows in FIGS. 2 and 4). In a case where the shape of a welded joint is a T-butt shape, the robot control device 6 moves the laser head 4 in the seam direction while maintaining a state in which the axial direction of the laser head 4 is tilted as illustrated in FIG. 2. Accordingly, the laser welding light L can be wobbled on the target surface while the laser welding light L is tilted so as to intersect both the first member W1 and the second member W2 at an angle greater than 0° and less than 90° on the target surface.

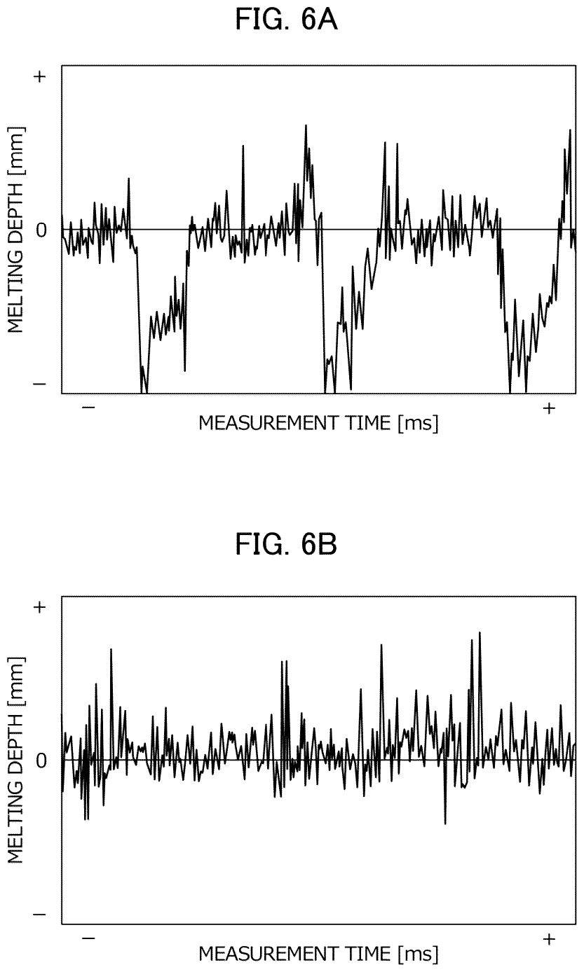

FIG. 5 is a diagram for description of the definition of the irradiation position of the laser welding light L when projected while being wobbled. More specifically, FIG. 5 is a view taken in the seam direction of the laser welding light L, illustrating the first member W1 and the second member W2.

In the following description, the center of the wobbling pattern drawn on the target surface of the first member W1 and the second member W2 in a width direction orthogonal to the seam direction is defined as an irradiation center point P of the laser welding light L. In addition, in the following description, the position of the irradiation center point P on the target surface of the first member W1 and the second member W2 is defined as a central irradiation position. Note that, in the example illustrated in FIG. 4, a sequence of points obtained by plotting the irradiation center point P in the seam direction is illustrated with a dashed and single-dotted line. In the following description, the central irradiation position is represented with reference to a reference point P0 determined on an end face of the first member W1 on the second member W2 side (in other words, interface between the first member W1 and the second member W2). More specifically, the central irradiation position is represented by a distance “a” between the reference point P0 and the irradiation center point P in the extending direction of the first member W1 as illustrated in FIG. 5.

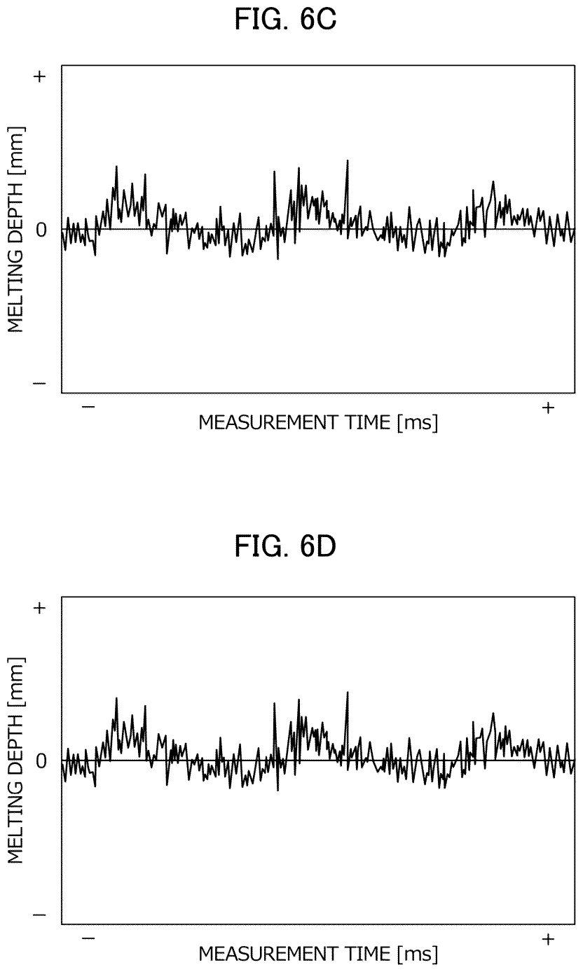

FIGS. 6A to 6D are diagrams illustrating examples of the time-series data of the melting depth measured by the depth measurement unit 71 at step ST1. More specifically, FIG. 6A illustrates the time-series data obtained in a case where the central irradiation position is set to 0.05 [mm], FIG. 6B illustrates the time-series data obtained in a case where the central irradiation position is set to 0.16 [mm], FIG. 6C illustrates the time-series data obtained in a case where the central irradiation position is set to 0.24 [mm], and FIG. 6D illustrates the time-series data obtained in a case where the central irradiation position is set to 0.39 [mm]. Note that FIGS. 6A to 6D illustrate cases where the shape of the wobbling pattern, the wobbling period, output of the laser welding light, and the like are kept constant and only the central irradiation position is changed. FIGS. 6A to 6D each illustrate the time-series data over three cycles of the wobbling period.

As illustrated in FIGS. 6A to 6D, the melting depth obtained when the laser welding light L is projected onto the welding target member W constituted by combining the first member W1 and the second member W2 as described above while the laser welding light L is wobbled periodically varies reflecting influence of reflection of the laser welding light L at the second member W2. As is apparent from comparison among FIGS. 6A to 6D, the periodic variation pattern of the melting depth differs depending on the central irradiation position of the laser welding light L. In other words, since the laser welding light L is wobbled while being tilted with respect to the target surface of the first member W1 and the second member W2, correlation appears between the variation pattern of the melting depth and the central irradiation position of the laser welding light L.

As illustrated in FIG. 3, at step ST2, in order to further clarify the correlation between the variation pattern of the melting depth and the central irradiation position as described above, the spectral data analysis unit 72 acquires spectral data by performing frequency analysis (for example, fast Fourier transform (FFT)) on the time-series data of the melting depth acquired by the depth measurement unit 71 at step ST1.

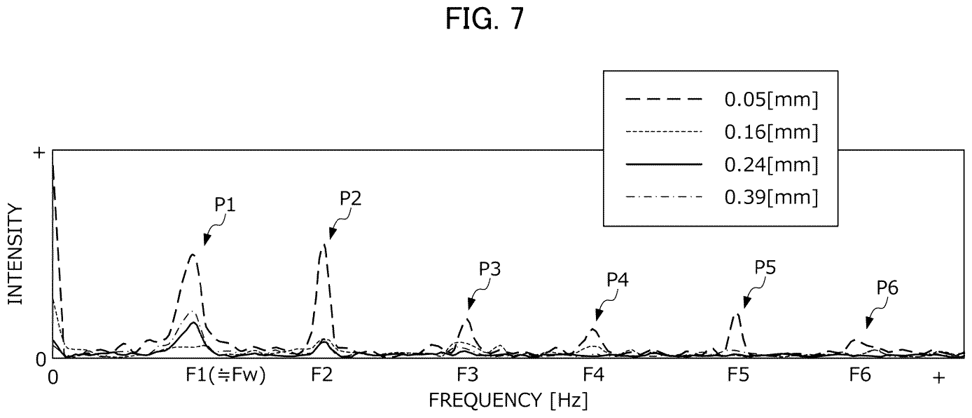

FIG. 7 is a diagram illustrating an example of the spectral data of the time-series data of the melting depth acquired by the spectral data analysis unit 72 at step ST2. In FIG. 7, the spectral data of the time-series data in a case where the central irradiation position is set to 0.05 [mm] (in other words, time-series data in FIG. 6A) is illustrated with a thick dashed line, the spectral data of the time-series data in a case where the central irradiation position is set to 0.16 [mm] (in other words, time-series data in FIG. 6B) is illustrated with a thin dashed line, the spectral data of the time-series data in a case where the central irradiation position is set to 0.24 [mm] (in other words, time-series data in FIG. 6C) is illustrated with a bold line, and the spectral data of the time-series data in a case where the central irradiation position is set to 0.39 [mm] (in other words, time-series data in FIG. 6D) is illustrated with a dashed and single-dotted line.

As illustrated in FIG. 7, in the spectral data of the time-series data of the melting depth, a plurality of peaks P1, P2, P3, P4, P5, P6, . . . appear at particular frequencies F1, F2, F3, F4, F5, F6, . . . . Note that the peak P1 appearing at the lowest frequency among the plurality of peaks P1 to P6 appearing in the spectral data appears at a frequency F1 substantially equal to a wobbling frequency Fw (F1≈Fw). The magnitude of each peak appearing in the spectral data has correlation with the central irradiation position, which is significant at peaks (P1, P2, and P3 in the example illustrated in FIG. 7) occurring at low-order frequencies (F1, F2, and F3 in the example illustrated in FIG. 7), in particular. Thus, the spectral data illustrated in FIG. 7 suggests that the central irradiation position can be estimated based on the magnitude of a peak appearing in the spectral data.

As illustrated in FIG. 3, at step ST3, in order to estimate the central irradiation position by utilizing the correlation between the intensity value at a peak and the central irradiation position as described above, the spectral data analysis unit 72 selects at least one peak from the spectral data acquired by the spectral data analysis unit 72 at step ST2 and acquires the intensity value representing the magnitude of the selected peak or an integral value of the intensity value as an input value for calculating the central irradiation position later at step ST4.

As described above, the correlation between the magnitude of each peak and the central irradiation position significantly appears at low-order frequencies, in particular. Thus, in a case where the plurality of peaks P1 to P6 appear in the spectral data as illustrated in FIG. 7, it is preferable that, at step ST3, the spectral data analysis unit 72 select the peak P1 appearing at the lowest frequency F1 among the plurality of peaks P1 to P6 and acquire the intensity value or the integral value at the peak P1 as the input value. In other words, it is preferable that the spectral data analysis unit 72 select the peak P1 at the frequency F1 corresponding to the wobbling frequency Fw among the plurality of peaks P1 to P6 and acquire the intensity value or the integral value at the peak P1 as the input value. The frequency corresponding to the wobbling frequency Fw means a frequency in the vicinity of the wobbling frequency Fw, more specifically, a frequency in the range of a predetermined frequency width (for example, ±Fw/2 approximately) centered at the wobbling frequency Fw.

As described above with reference to FIG. 7, a plurality of peaks appear in the spectral data. Thus, it is preferable that, at step ST3, the spectral data analysis unit 72 select two or more peaks from among the plurality of peaks P1 to P6 appearing in the spectral data and acquire the intensity value or the integral value at each of the selected peaks as the input value. Moreover, the correlation between the magnitude of each peak and the central irradiation position significantly appears at low-order frequencies, in particular. Thus, it is preferable that, at step ST3, the spectral data analysis unit 72 select two or more peaks P1, P2, . . . sequentially from the lowest frequency F1 from among the plurality of peaks P1 to P6 appearing in the spectral data and acquire the intensity value or the integral value at each of the selected peaks P1, P2, . . . as the input value.

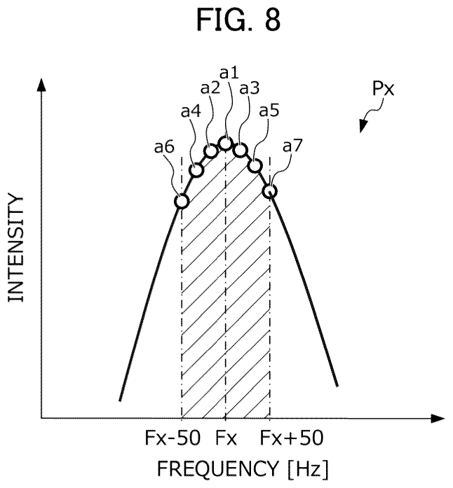

FIG. 8 is a diagram for description of a procedure of acquiring the input value from the peak Px appearing at a predetermined frequency Fx in the spectral data.

As illustrated in FIG. 8, the spectral data analysis unit 72 may acquire the intensity value of the spectral data at the predetermined frequency Fx (point a1 in FIG. 8) as the input value, or may acquire the integral value (area value of a hatched region in FIG. 8) of the intensity value over a predetermined frequency width (for example, ±50 [Hz] approximately) centered at the frequency Fx as the input value.

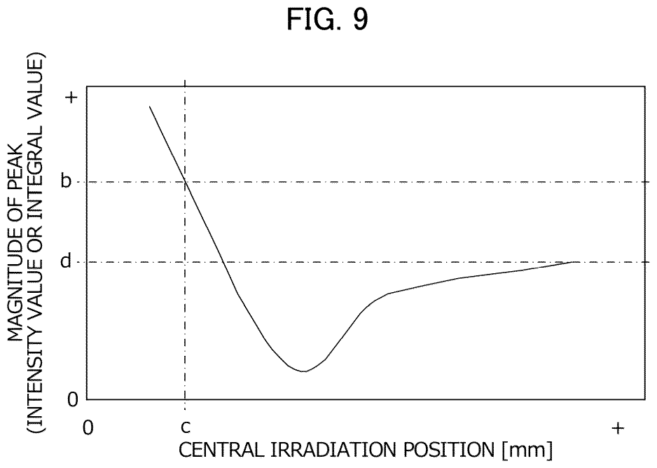

As illustrated in FIG. 3, at step ST4, the spectral data analysis unit 72 calculates the central irradiation position of the laser welding light L based on the at least one input value acquired at step ST3. More specifically, the spectral data analysis unit 72 calculates the central irradiation position of the laser welding light L based on the input value acquired at step ST3 and the correlation between the intensity value and the central irradiation position (refer to FIG. 9, for example), which is measured in advance.

FIG. 9 is a diagram illustrating the correlation between the magnitude of a peak appearing at a specific frequency in the spectral data and the central irradiation position. More specifically, FIG. 9 illustrates a curve defining the correlation between the intensity value or the integral value (vertical axis) representing the magnitude of the peak P1 appearing at the lowest frequency F1 in the spectral data in FIG. 7 and the central irradiation position (horizontal axis). The spectral data analysis unit 72 calculates the central irradiation position by comparing the input value acquired at step ST3 with the curve defining the correlation between the intensity value or the integral value and the central irradiation position as illustrated in FIG. 9. Specifically, in the example illustrated in FIG. 9, when the input value is “b”, the central irradiation position is “c”.

More specifically, the spectral data analysis unit 72 includes a storage medium in which data (hereinafter, referred to as “curve data”) of the curve defining the correlation between the intensity value or the integral value and the central irradiation position as illustrated in FIG. 9 is stored for each peak appearing in the spectral data. Then, at step ST4, the spectral data analysis unit 72 calculates the central irradiation position by comparing the curve data corresponding to each peak selected at step ST3 with the input value (in other words, the intensity value or the integral value at the selected peak) acquired at step ST3.

The curve illustrated in FIG. 9 is convex downward when the vertical axis represents the intensity value or the integral value and the horizontal axis represents the central irradiation position. This means that the curve defining the correlation between the intensity value or the integral value and the central irradiation position is a multivalued function with respect to the intensity value or the integral value. Specifically, in the example illustrated in FIG. 9, the central irradiation position can be uniquely calculated from the input value when the input value is larger than “d”, but the central irradiation position cannot be uniquely calculated only from the input value when the input value is equal to or smaller than “d”. In such a case, it is preferable that the spectral data analysis unit 72 select two or more peaks and acquire the intensity value or the integral value at each of the selected peaks as the input value at step ST3 and calculate the central irradiation position at step ST4 by comparing the two or more input values acquired at step ST3 with two or more pieces of the curve data determined for the respective peaks selected at step ST3. In this manner, by comparing the input value and the curve data for each of the two or more peaks, it is possible to uniquely calculate the central irradiation position from the plurality of input values even when the curve is a multivalued function as described above.

As illustrated in FIG. 3, at step ST5, the quality inspection unit 73 evaluates the quality of a weld of the welding target member W based on the central irradiation position calculated at step ST4. In a case where the first member W1 is a busbar of a secondary battery, the second member W2 is a tab lead of the secondary battery, and the shape of a welded joint between the first member W1 and the second member W2 is a T-butt shape as described above, internal defects may occur if the central irradiation position of the laser welding light L is made too close to the second member W2. In addition, defective joining may occur if the central irradiation position is made too far from the second member W2. In this manner, the central irradiation position of the laser welding light L has correlation with the quality of a joint. Thus, the quality inspection unit 73 evaluates the quality of a weld based on the central irradiation position calculated at step ST4. More specifically, it is preferable that the quality inspection unit 73 determine that the quality of a weld is “good” when the central irradiation position calculated at step ST4 is within a predetermined inspection reference range, and determine that the quality of the weld is “defective” when the central irradiation position is outside the above-described inspection reference range.

As described above, according to the laser irradiation position measurement method and the laser welding inspection method illustrated in FIG. 3, the melting depth and the central irradiation position can be measured while the welding target member W is welded by the laser welding light L, and the quality of a joint can be evaluated.

The laser irradiation position measurement method and the laser welding inspection method according to the present embodiment achieve effects as follows.
(1) In the present embodiment, at step ST1, the laser welding light L is projected while being wobbled on the target surface of the welding target member W including the first member W1 and the second member W2 extending in a direction intersecting the first member W1, and the time-series data of the melting depth at the irradiation point of the laser welding light L is acquired; at step ST2, spectral data is acquired by performing frequency analysis on the time-series data; and at step ST3, an intensity value representing the magnitude of at least one peak or an integral value of the intensity value among a plurality of peaks appearing in the spectral data is acquired as an input value. The waveform of the melting depth at the irradiation point periodically changes when the laser welding light L is projected while being wobbled on the welding target member W formed by combining the first member W1 and the second member W2 as described above. As described above with reference to FIGS. 7 and 9, in particular, the magnitude of a peak appearing at a particular frequency in spectral data of the waveform of the melting depth has correlation with the central irradiation position of the laser welding light L with respect to the welding target member W. In the present embodiment, such a relation between the magnitude of a peak appearing in the spectral data and the central irradiation position is utilized at step ST4 to calculate the central irradiation position of the laser welding light L based on the input value acquired at step ST3. Thus, according to the present embodiment, the central irradiation position of the laser welding light L can be measured while the first member W1 and the second member W2 are welded by wobbling-welding. In a case where the first member W1 is a busbar of a secondary battery and the second member W2 is a tab lead thereof as described above, the central irradiation position of the laser welding light L has correlation with the quality of a product (in particular, a joint between the busbar and the tab lead), and since the central irradiation position of the laser welding light L can be measured by using the laser irradiation position measurement method, high-quality secondary batteries can be manufactured, which can contribute to improvement in energy efficiency.
(2) In the present embodiment, at step ST4, the central irradiation position is calculated by comparing the input value acquired at step ST3 with a curve defining the correlation between the intensity value or the integral value and the central irradiation position. Thus, according to the present embodiment, the central irradiation position can be calculated by simple calculation.
(3) As described above with reference to FIG. 9, the curve defining the correlation between the intensity value or the integral value and the central irradiation position is a multivalued function with respect to the intensity value or the integral value in some cases. Thus, at step ST3, two or more peaks are selected from among a plurality of peaks appearing in the spectral data, the intensity value or the integral value at each of the selected peaks is acquired as the input value, and at step ST4, the central irradiation position is calculated by comparing the two or more input values acquired at step ST3 with the two or more curves determined for the respective peaks selected at step ST3. In this manner, in the present embodiment, the central irradiation position can be uniquely calculated by using the two or more input values even when the curve is a multivalued function as described above.
(4) As described above with reference to FIG. 7, in the spectral data of the waveform of the melting depth, peaks appear at one or more particular frequencies F1, F2 . . . determined in accordance with the wobbling frequency Fw. In step ST3, the intensity value or the integral value at a peak at the frequency F1 corresponding to the wobbling frequency Fw among a plurality of peaks is acquired as the input value. Thus, according to the present embodiment, the central irradiation position can be calculated by simple calculation.
(5) As described above with reference to FIG. 7, a peak appearing at the lowest frequency tends to have the largest magnitude among a plurality of peaks appearing in the spectral data of the waveform of the melting depth. Thus, at step ST3, the central irradiation position can be accurately calculated by acquiring, as the input value, the intensity value or the integral value at a peak appearing at the lowest frequency among a plurality of peaks appearing in the spectral data.
(6) In the present embodiment, at step ST1, by tilting the laser welding light L so as to intersect both the first member W1 and the second member W2 at an angle greater than 0° and less than 90° on the target surface of the welding target member W, the central irradiation position of the laser welding light L can be measured while the first member W1 and the second member W2 are appropriately joined by welding.
(7) In the present embodiment, at step ST1, the laser welding light L and measurement light S are wobbled on the target surface while being coaxially projected, and time-series data of the melting depth is acquired by detecting the measurement light S reflected from the irradiation point. Accordingly, the time-series data of the melting depth at the irradiation point, which moves by wobbling the laser welding light L, can be easily acquired.

Although the embodiment of the present invention is described above, the present invention is not limited thereto. Detailed configurations may be changed as appropriate within the scope of the spirit of the present invention.

For example, the above description of the embodiment is made on a case where the intensity value (point a1 in FIG. 8) of the spectral data at predetermined the frequency Fx is acquired as the input value as described above with reference to FIG. 8, but the present invention is not limited thereto.

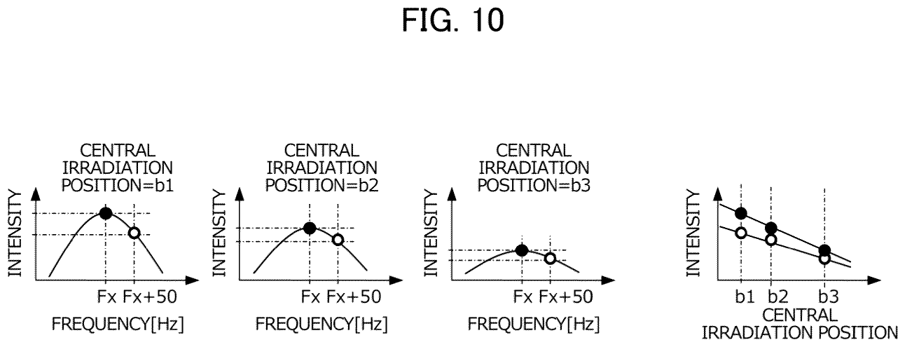

FIG. 10 is a diagram schematically illustrating the correlation between the shape of the peak Px appearing at the predetermined frequency Fx in the spectral data and the central irradiation position. The three diagrams on the left side in FIG. 10 are diagrams illustrating the shape of the peak Px in a case where the central irradiation position is set to b1, b2, and b3, respectively, and the one diagram on the right side in FIG. 10 is a diagram illustrating the relation between the intensity value at the peak Px at the predetermined frequency and the central irradiation position.

As illustrated in FIG. 10, the height (intensity value) of the peak Px tends to change not only at the frequency Fx at the center but also its vicinity when the central irradiation position is changed. Thus, at step ST3, the spectral data analysis unit 72 may acquire, as the input value for the peak Px, an optional intensity value (points a1 to a7 in FIG. 8) in a predetermined frequency width (for example, ±50 [Hz] approximately) centered at the frequency Fx.

In the laser welding inspection method described above with reference to FIG. 3, for example, the input value is acquired based on the spectral data (refer to step ST3), the central irradiation position of the laser welding light L is calculated based on the input value (refer to step ST4), and then, the quality of a weld of the welding target member W is evaluated based on the central irradiation position (refer to step ST5), but the present invention is not limited thereto. Since the input value acquired at step ST3 also has correlation with the quality of the weld, the quality of the weld may be evaluated based on the input value without calculation of the central irradiation position as described in a modification described below.

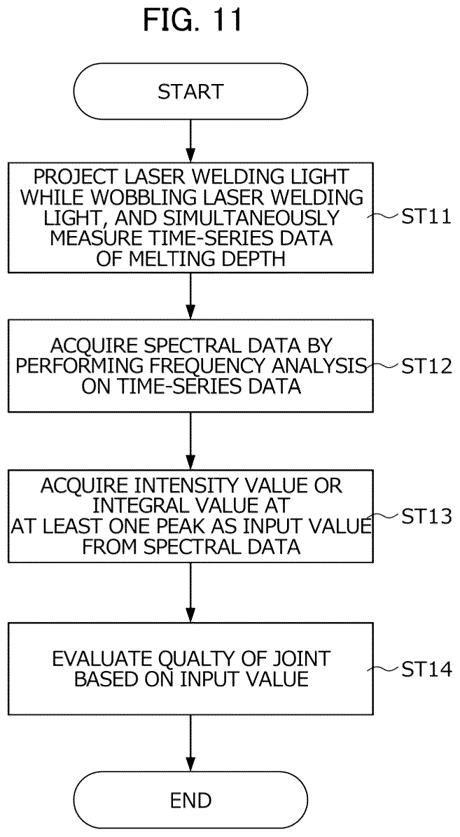

FIG. 11 is a flowchart illustrating a specific procedure of the laser welding inspection method according to the modification. Note that processes at steps ST11 to ST12 in the flowchart illustrated in FIG. 11 are the same as the processes at steps ST1 to ST2 in the flowchart illustrated in FIG. 3, and thus detailed description thereof is omitted.

At step ST13, the spectral data analysis unit 72 selects at least one peak from the spectral data acquired at step ST12 and acquires an intensity value representing the magnitude of the selected peak or an integral value of the intensity value as an input value for evaluating the quality of a weld at step ST14 later. Note that a specific procedure of acquiring the input value is the same as that of the process at step ST3 in the flowchart of FIG. 3, and detailed description thereof is omitted.

Subsequently at step ST14, the quality inspection unit 73 evaluates the quality of a weld of the welding target member W based on the input value acquired at step ST13. More specifically, it is preferable that the quality inspection unit 73 determine that the quality of a weld is “good” when the input value acquired at step ST13 is within a predetermined inspection reference range, and determine that the quality of the weld is “defective” when the input value is outside the above-described inspection reference range.

What is claimed is:

1. A laser irradiation position measurement method of measuring an irradiation position of laser welding light with respect to a target member including a first member and a second member extending in a direction intersecting the first member, the laser irradiation position measurement method comprising:
(A) projecting the laser welding light while wobbling the laser welding light on a target surface of the target member, and acquiring time-series data of a depth at an irradiation point of the laser welding light;
(B) performing frequency analysis on the time-series data and acquiring spectral data;
(C) acquiring, from the spectral data, an intensity value at at least one peak or an integral value of the intensity value as an input value; and
(D) calculating the irradiation position of the laser welding light based on the input value.

2. The laser irradiation position measurement method according to claim 1, wherein in (D), the irradiation position is calculated by comparing a curve defining a correlation between the intensity value or the integral value and the irradiation position with the input value.

3. The laser irradiation position measurement method according to claim 2, wherein in (C), two or more peaks are selected from among a plurality of peaks, and the intensity value or the integral value at each of the selected peaks is acquired as the input value, and
in (D), the irradiation position is calculated by comparing two or more of the input values acquired in (C) with two or more of the curves determined for the respective selected peaks in (C).

4. The laser irradiation position measurement method according to claim 1, wherein in (C), the intensity value or the integral value at a peak at a frequency corresponding to a wobbling frequency among a plurality of peaks is acquired as the input value.

5. The laser irradiation position measurement method according to claim 1, wherein in (C), the intensity value or the integral value at a peak appearing at a lowest frequency among a plurality of peaks is acquired as the input value.

6. The laser irradiation position measurement method according to claim 1, wherein in (A), the laser welding light is tilted so as to intersect both the first member and the second member at an angle greater than 0° and less than 90° on the target surface.

7. The laser irradiation position measurement method according to claim 1, wherein in (A), the laser welding light and measurement light are wobbled on the target surface while being coaxially projected, and the time-series data is acquired by detecting the measurement light reflected from the irradiation point.

8. The laser irradiation position measurement method according to claim 2, wherein in (C), the intensity value or the integral value at a peak at a frequency corresponding to a wobbling frequency among a plurality of peaks is acquired as the input value.

9. The laser irradiation position measurement method according to claim 2, wherein in (C), the intensity value or the integral value at a peak appearing at a lowest frequency among a plurality of peaks is acquired as the input value.

10. The laser irradiation position measurement method according to claim 2, wherein in (A), the laser welding light is tilted so as to intersect both the first member and the second member at an angle greater than 0° and less than 90° on the target surface.

11. The laser irradiation position measurement method according to claim 2, wherein in (A), the laser welding light and measurement light are wobbled on the target surface while being coaxially projected, and the time-series data is acquired by detecting the measurement light reflected from the irradiation point.

12. The laser irradiation position measurement method according to claim 3, wherein in (C), the intensity value or the integral value at a peak at a frequency corresponding to a wobbling frequency among a plurality of peaks is acquired as the input value.

13. The laser irradiation position measurement method according to claim 3, wherein in (C), the intensity value or the integral value at a peak appearing at a lowest frequency among a plurality of peaks is acquired as the input value.

14. The laser irradiation position measurement method according to claim 3, wherein in (A), the laser welding light is tilted so as to intersect both the first member and the second member at an angle greater than 0° and less than 90° on the target surface.

15. The laser irradiation position measurement method according to claim 3, wherein in (A), the laser welding light and measurement light are wobbled on the target surface while being coaxially projected, and the time-series data is acquired by detecting the measurement light reflected from the irradiation point.

16. A laser welding inspection method of inspecting quality of a joint formed by projecting laser welding light onto a target member including a first member and a second member extending in a direction intersecting the first member, the laser welding inspection method comprising:
(A) projecting the laser welding light while wobbling the laser welding light on a target surface of the target member, and acquiring time-series data of a depth at an irradiation point of the laser welding light;
(B) performing frequency analysis on the time-series data and acquiring spectral data;
(C) acquiring, from the spectral data, an intensity value at at least one peak or an integral value of the intensity value as an input value; and
(D) inspecting the quality of the joint based on the input value.
